(19) United States
(12) Patent Application Publication
(10) Pub. No.: US 2013/0107849 A1
(43) Pub. Date: May 2, 2013

(54) METHOD, TERMINAL, AND BASE STATION FOR TRANSMITTING AND RECEIVING CHANNEL INFORMATION

(71) Applicant: Kyoungmin Park, Seoul (KR)

(72) Inventor: Kyoungmin Park, Seoul (KR)

(73) Assignee: Pantech Co., Ltd., Seoul (KR)

(21) Appl. No.: 13/807,696

(22) PCT Filed: Jun. 30, 2011
(86) PCT No.: PCT/KR2011/004808

§ 371 Date: Dec. 28, 2012

(30) Foreign Application Priority Data
Jul. 1, 2010 (KR) 10-2010-0063612

(51) Int. Cl. H04B 7/04

(52) U.S. Cl. CPC H04B 7/0417
USPC 370/329; 370/328

(57) ABSTRACT

A wireless communication system uses multiple-input multiple-output (MIMO) antennas for both transmitting and receiving ends. The features are characterized by a step for receiving feedback from at least one terminal at a base station on a first channel state information and a second channel state information at intervals different from each other; and a step for receiving feedback, when the terminal and at least one other terminal are simultaneously allowed to connect, on multiple-access information on the other terminal from among the first channel state information and the second channel state information which has the shorter interval but which is longer than one interval.

This application is the National Stage Entry of International Application No. PCT/KR2011/004808, filed on Jun. 30, 2011 and claims priority from and the benefit of Korean Patent Application No. 10-2010-0063612, filed on Jul. 1, 2010, both of which are hereby incorporated by reference for all purposes as if fully set forth herein.

### BACKGROUND

1. Field

The present invention relates to a wireless communication system, and more particularly to a wireless communication system, in which transmission and reception sides both use Multiple-Input Multiple-Output (MIMO) antennas.

2. Discussion

With the progress of communication systems, consumers such as companies and individuals have used a wide variety of wireless terminals.

In current mobile communication systems such as a 3GPP LTE (3rd Generation Partnership Project Long Term Evolution) and a 3GPP LTE-A (LTE Advanced), as a high-speed and high-capacity communication system capable of transmitting and receiving various data such as images and wireless data beyond voice-oriented services, it is required to develop a technology capable of transmitting a large amount of data coming close to that of a wired communication network. In addition, it is required to improve system performance by minimizing information loss and increasing system transmission efficiency.

Meanwhile, use has been made of a communication system in which transmission and reception sides both use Multiple-Input Multiple-Output (MIMO) antennas. The MIMO communication system has a structure, in which a single user equipment receives or transmits a signal from/to one base station and the like, or in which multiple user equipments receive or transmit signals from/to one base station and the like.

The MIMO communication system requires a process for detecting a channel state by using multiple reference signals and feeding back the detected channel state to a transmission side (another apparatus).

### SUMMARY

In accordance with an aspect of the present invention, there is provided a method for receiving channel information by a base station, which includes: receiving, as feedback, first channel state information and second channel state information from at least one user equipment during different cycles; and receiving, as feedback, multiple access information of at least one user equipment different from the user equipment during a cycle longer than a shorter cycle among a cycle of the first channel state information and a cycle of the second channel state information, when simultaneous access of the user equipment and the different user equipment is allowed.

In accordance with another aspect of the present invention, there is provided a method for transmitting channel information by a user equipment, which includes: estimating a channel with reference to a reference signal received from a base station; generating channel information including first channel state information, second channel state information, and multiple access information of at least one user equipment different from a user equipment in a case where simultaneous access of the user equipment and the different user equipment is allowed, by using the estimated channel; and feeding back the first channel state information and the second channel state information to the base station during different cycles, and feeding back the multiple access information to the base station during a cycle longer than a shorter cycle among a cycle of the first channel state information and a cycle of the second channel state information.

In accordance with still another aspect of the present invention, there is provided an apparatus for transmitting channel information, which includes: a channel estimator for estimating a channel by using a reference signal received from a base station; a channel information generator for generating channel information including first channel state information, second channel state information, and multiple access information of at least one user equipment different from a user equipment in a case where simultaneous access of the user equipment and the different user equipment is allowed, by using the estimated channel; and a feedback unit for feeding back the first channel state information and the second channel state information to the base station during different cycles, and feeding back the multiple access information during a cycle longer than a shorter cycle among a cycle of the first channel state information and a cycle of the second channel state information.

In accordance with yet another aspect of the present invention, there is provided a base station, which includes: a layer mapper for mapping a codeword to a layer; first and second precoders for receiving, as feedback, first channel state information and second channel state information from at least one user equipment during different cycles, and precoding mapped symbols by using precoding matrixes thereof; a scheduler for receiving, as feedback, multiple access information of at least one user equipment different from the user equipment during a cycle longer than a shorter cycle among a cycle of the first channel state information and a cycle of the second channel state information when the user equipment allows simultaneous access of the user equipment and the different user equipment, selecting a user equipment which is to receive data, and generating precoding matrixes of the first and second precoders; and an antenna array including two or more antennas for propagating a precoded symbol over the air.

In accordance with still yet another aspect of the present invention, there is provided a transmission method by a base station, which includes: mapping a codeword to a layer; selecting a user equipment which is to receive data, after receiving, as feedback, first channel state information and second channel state information of a user equipment during different cycles and receiving, as feedback, multiple access information of at least one user equipment different from the user equipment during a cycle longer than a shorter cycle among a cycle of the first channel state information and a cycle of the second channel state information when the user equipment allows simultaneous access of the user equipment and the different user equipment; generating a precoding matrix of each of a first precoder and a second precoder with respect to the user equipment selected in selecting of the user equipment; precoding the mapped symbols by using the precoding matrixes; and propagating a precoded symbol over the air through an antenna array including two or more antennas.

### BRIEF DESCRIPTION OF DRAWINGS

FIG. 1 is a view schematically showing a wireless communication system, to which exemplary embodiments of the present invention are applied.

FIG. 2 shows that a base station transmits a reference signal to each of user equipments in a wireless communication system.

FIG. 3 shows that each of user equipments transmits channel state information and multiple access information to a base station in a wireless communication system according to an embodiment of the present invention.

FIG. 4 to FIG. 6 are block diagrams each showing configurations of the base station and each user equipment as shown in FIG. 2 and FIG. 3.

FIG. 7 is a block diagram showing each function of a channel information feedback apparatus according to an embodiment of the present invention in a MIMO system.

FIG. 8 is a block diagram showing the configuration of a channel information generator as shown in FIG. 7.

FIG. 9 is a flowchart showing a method for feeding back (transmitting) channel information according to another embodiment of the present invention in a MIMO system.

FIG. 10 is a flowchart showing an example of a method for generating channel information according to still another embodiment of the present invention.

FIG. 11 is a block diagram showing the configuration of a base station according to yet another embodiment of the present invention.

FIG. 12 is a flowchart showing a transmission method of the base station according to yet another embodiment of the present invention.

### DETAILED DESCRIPTION OF THE ILLUSTRATED EMBODIMENTS

Hereinafter, exemplary embodiments of the present invention will be described in detail with reference to the accompanying drawings. It should be noted that in assigning reference numerals to elements in the drawings, the same elements will be designated by the same reference numerals although they are shown in different drawings. Also, in describing the present invention, a detailed description of publicly-known functions or configurations related to the present invention will be omitted when it is determined that the detailed description thereof may unnecessarily obscure the subject matter of the present invention.

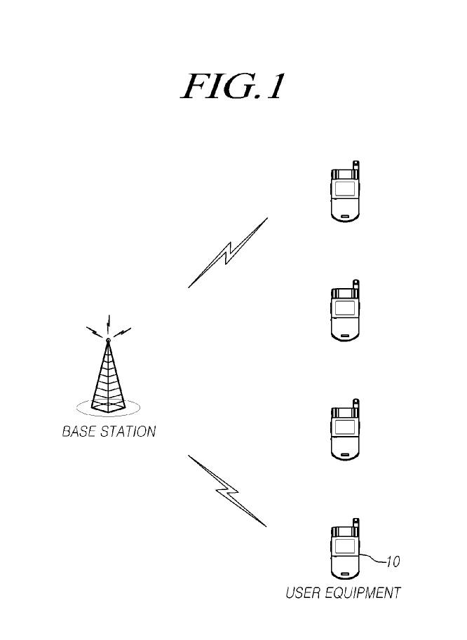

FIG. 1 shows a wireless communication system, to which exemplary embodiments of the present invention are applied.

The wireless communication system is widely arranged in order to provide various communication services, such as voice, packet data, etc.

Referring to FIG. 1, the wireless communication system includes a User Equipment (UE) 10 and a Base Station (BS) 20.

In this specification, the UE 10 has a comprehensive concept implying a user terminal in wireless communication. Accordingly, the UEs should be interpreted as having the concept of including an MS (Mobile Station), a UT (User Terminal), an SS (Subscriber Station), a wireless device, and the like in GSM (Global System for Mobile Communications) as well as UEs (User Equipments) in WCDMA (Wideband Code Division Multiple Access), LTE (Long Term Evolution), HSPA (High Speed Packet Access), etc.

The BS 20 or a cell usually refers to a fixed station communicating with the UE 10, and may be called different terms, such as a Node-B, an eNB (evolved Node-B), a BTS (Base Transceiver System), an AP (Access Point), and a relay node.

In this specification, the UE 10 and the BS 20, which are two transmission and reception subjects used to implement a technology or a technical idea described in this specification, are used as a comprehensive meaning, and are not limited by a particularly designated term or word.

An embodiment of the present invention may be applied to both the field of asynchronous wireless communications which have gone through GSM, WCDMA and HSPA, and evolve into LTE (Long Term Evolution) and LTE-A (Long Term Evolution-Advanced), and the field of synchronous wireless communications which evolve into CDMA (Code Division Multiple Access), CDMA-2000 and UMB (Ultra Mobile Broadband). The present invention should not be interpreted as being limited to or restricted by a particular wireless communication field, but should be interpreted as including all technical fields to which the spirit of the present invention can be applied

The wireless communication system, to which exemplary embodiments of the present invention are applied, may support an uplink and/or downlink HARQ (Hybrid Automatic Repeat reQuest), and may use a CQI (Channel Quality Indicator) for link adaptation. Also, multiple access schemes for downlink transmission and uplink transmission may be different from each other. For example, OFDMA (Orthogonal Frequency Division Multiple Access) may be used for downlink transmission, and SC-FDMA (Single Carrier-Frequency Division Multiple Access) may be used for uplink transmission.

The wireless communication system considers the use of a Multiple-User Multiple-Input Multiple-Output (MU-MIMO) technique for simultaneously delivering information to multiple users in an identical band by using multiple antennas in order to support the transmission of information to many users at a high speed. When two or more UEs have a high channel propagation gain in an identical band, the MU-MIMO allows the two users to share the band and enables more users to use a wider band and a band having a better channel propagation gain, so as to enable an improvement in overall spectral efficiency.

Meanwhile, a precoder which is based on channel information, may be used to implement an effective MIMO system. To this end, there is a need for a scheme, in which the UE 10 detects a channel state and notifies the BS 20 of the detected channel state.

The schemes in which the UE 10 delivers channel information may be largely divided into a scheme (explicit feedback scheme) in which the UE 10 directly notifies the BS 20 of channel information and a scheme (implicit feedback scheme) in which the UE 10 determines a precoder scheme based on channel information and notifies the BS 20 of the determined precoder scheme. As compared with the former (explicit feedback), the latter has an advantage in that even small overhead enables closed loop precoding. However, because the BS may not be notified of direct information on a channel, interference between users may not be effectively controlled when the MU-MIMO is implemented.

In order to effectively control the interference between users in the case of implementing the MU-MIMO while the closed loop precoding scheme is used, use may be made of a scheme, in which information on the use of a precoder is implicitly fed back based on channel information and information for supporting multiple access is implicitly fed back at the same time.

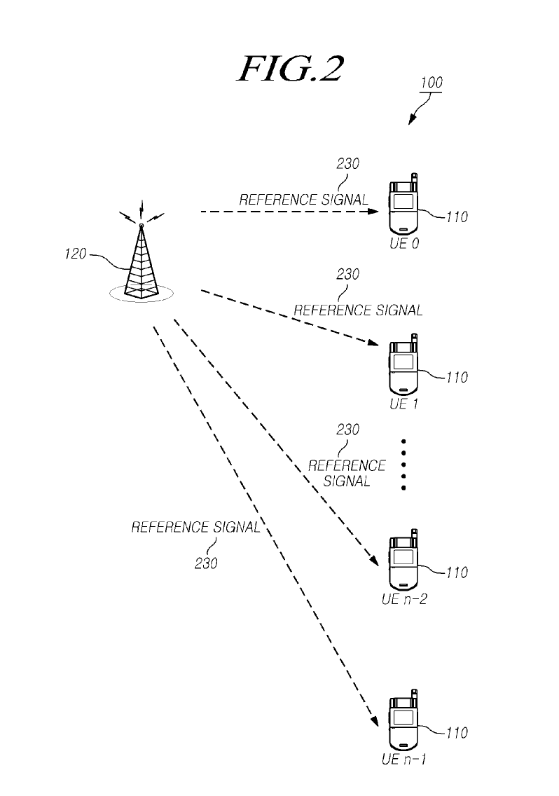

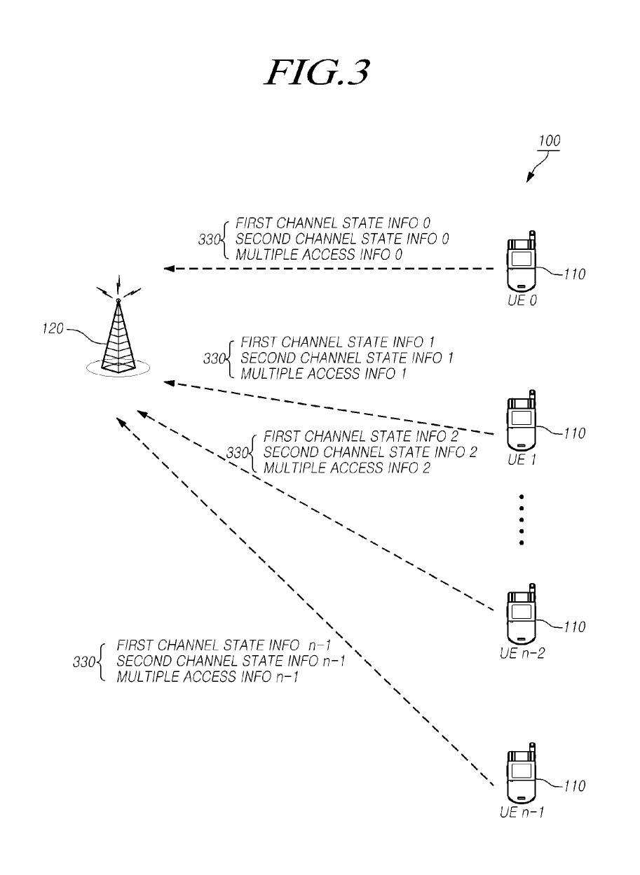

Hereinabove, the wireless communication system to which exemplary embodiments of the present invention are applied, has been described. Hereinafter, a process in which a BS and each of user equipments exchange a reference signal and channel information with each other in the wireless communication system, will be described with reference to FIG. 2 and FIG. 3.

FIG. 2 shows that a base station transmits a reference signal to each of user equipments in a wireless communication system. FIG. 3 shows that each of user equipments transmits channel state information and multiple access information to a base station in a wireless communication system according to an embodiment of the present invention.

Referring to FIG. 2 and FIG. 3, a wireless communication system 100 may include a BS 120 and at least one UE, for example, an n number of UEs 110 (UE₀ to UEₙ₋₁), which exist in the wireless communication system 100, as in the wireless communication system shown in FIG. 1. Each of the UEs 110 may be a UE which is currently connected or attempts an additional connection.

Referring to FIG. 2, in order to transmit and receive data between the UE 110 and the BS 120, the BS 120 on a transmitter side transmits a reference signal 230 to the UE 110, and the UE 110 on a receiver side may estimate a frequency domain channel by using the reference signal. For example, during downlink transmission, the UE 110 may estimate a downlink channel. Particularly, during OFDM transmission, the UE 110 may estimate a channel of each subcarrier. In contrast, during uplink transmission, the BS 120 may estimate an uplink channel.

In order to estimate a frequency domain channel, a particular signal or a particular symbol may be inserted into a frequency domain grid at regular or irregular intervals. At this time, the particular signal or the particular symbol is variously named a reference signal, a reference symbol, or a pilot symbol. In this specification, the particular signal or the particular symbol is referred to as a “reference signal,” but the present invention is not limited to the term. It goes without saying that the reference signal 230 is not used only to estimate a frequency domain channel but may also be used for location estimation, the transmission and reception of control information, the transmission and reception of scheduling information, and the transmission and reception of feedback information, which are necessary for a wireless communication process between the UE and the BS.

During downlink or uplink transmission, various types of reference signals exist, and new reference signals are defined and are also discussed, for various purposes. For example, as reference signals during uplink transmission, a DM-RS (Demodulation Reference Signal) and an SRS (Sounding Reference Signal) are used. As reference signals during downlink transmission, a CRS (Cell-specific RS), an MBSFN RS and a UE-specific RS are used. Also, a CSI-RS is used as a reference signal that the BS transmits to the UE 110 in order to cause the UE 110 to acquire Channel State Information (CSI) of a center cell or adjacent cells during downlink transmission. The CSI-RS may be used to report a CQI (Channel Quality Indicator), a PMI (Precoding Matrix Indicator), an RI (Rank Indication), etc. The CSI-RSs are subjected to being cell-specific so that they may be distinguished according to cells included in the BS that transmits the CSI-RS, and must be sufficiently scattered in frequency and time for small overhead.

Referring to FIG. 3, each UE 110 receives the reference signal 230, and estimates a channel. Thereafter, each UE 110 feeds back channel information 330 to the BS 120. At this time, the channel information includes channel state information on each UE itself (hereinafter, referred to as “channel state information”) and multiple access information on another UE due to multiple access determined by each UE itself or interference information due to the multiple access (hereinafter, referred to as “multiple access information”). The channel state information may include first channel state information and second channel state information.

At this time, the first channel state information and the second channel state information may include information on precoding (referred to as “precoding” or “PC”) of each UE itself which is appropriate for the estimated channel, for example, a PMI (Precoding Matrix Indicator) corresponding to an index of a precoding matrix.

A feedback cycle or interval of the first channel state information may be different from that of the second channel state information. Namely, one of the first channel state information and the second channel state information may be fed back to the BS 120 in the form of entire band/long cycle/long term (wideband/long-term) channel state information, and the other may be fed back to the BS 120 in the form of particular band/short cycle/short term (subband/short-term) channel state information. For example, the first channel state information may be fed back to the BS 120 at short term intervals, and the second channel state information may be fed back to the BS 120 at long term intervals. As described below, the term “subband/short-term” may refer to a cycle, during which one propagation channel is estimated and the channel information is fed back, and the term “wideband/long-term” may refer to a cycle, during which statistical properties of at least two propagation channels are calculated and the channel information is fed back. In other words, the meaning of wideband/long-term is contrary to that of subband/short-term, and thus, the wideband/long-term signifies a longer cycle than the subband/short-term.

Specifically, the first channel state information is a first index (first PMI) of a precoding matrix of each UE itself, which is appropriate for a channel estimated in a narrow band, a particular frequency band, or a particular subchannel (frequency-selective or subband) corresponding to a subset of an available entire band. The first channel state information may be selected from a codebook that each UE itself stores therein, and may be fed back to the BS 120 at short feedback intervals. Meanwhile, the second channel state information is a second index (second PMI) of a precoding matrix of each UE itself, which is appropriate for a channel estimated in a wideband corresponding to the entire band. The second channel state information may be selected from the codebook that each UE itself stores therein, and may be fed back to the BS 120 at long feedback intervals.

At the relevant part of this specification, the first channel state information or the first index may be interpreted as being in the form of subband/short-term, and the second channel state information or the second index may be interpreted as being in the form of wideband/long-term.

For example, in the case of MIMO allowing simultaneous access of an n number of UEs, each of the n number of UEs 110 may feed back the first channel state information and/or the second channel state information to the BS 120 during different cycles. Meanwhile, the BS 120 may receive, as feedback, n pieces of first channel state information and/or n pieces of second channel state information, which are reported by the n number of UEs, during different cycles.

Also, each UE 110 may measure a channel capacity or a channel quality by using a reference signal, and may report a measured value, as first channel quality information, to the BS 120.

Also, when the BS 120 transmits a signal according to the channel state information that the BS 120 has received as feedback from each UE 110, multiple access information may include either information on precoding of each of the other UEs, which is expected to have a small amount of interference received by each UE, or information on precoding of each of the other UEs, which is expected to have, in contrast, a large amount of interference received by each UE, for example, an index of at least one precoding matrix of the other UEs. At this time, an index used for the multiple access information may be selected from a codebook that each UE itself stores therein. This codebook may be identical to or different from the codebook used for the first channel state information and the second channel state information as described above.

Meanwhile, the multiple access information may be fed back to the BS 120 during a cycle or at intervals, which is (or are) longer than a shorter feedback cycle or interval among a feedback cycle or interval of the first channel state information and that of the second channel state information as described above. For example, the multiple access information may be fed back to the BS 120 during a cycle or at intervals, which is (are) longer than a shorter feedback cycle or interval among a feedback cycle or interval of the first channel state information and that of the second channel state information as described above, and which is (are) identical to a longer feedback cycle or interval thereamong. Specifically, when the second channel state information has a feedback cycle longer than that of the first channel state information, the multiple access information may have a feedback cycle identical to that of the second channel state information. However, the present invention is not limited to this configuration. In this case, the multiple access information may also have a wideband/long-term property as in the case of the second channel state information.

For example, in the case of MIMO allowing simultaneous access of an n number of UEs, each of the n number of UEs 110 may feed back multiple access information on each of an (n−1) number of the other UEs to the BS 120. Meanwhile, the BS 120 may receive, as feedback, n×(n−1) pieces of multiple access information, which are reported by the n number of UEs.

When each UE itself and another UE gain multiple access to the BS 120 by using the first channel state information and the second channel state information, and the multiple access information, which the UE itself has reported to the BS 120, each UE 110 may calculate a channel capacity or a channel quality, and may report a calculated value, as second channel quality information, to the BS 120.

The BS 120 determines SU-MIMO transmission or MU-MIMO transmission based on channel information 330 including two pieces of channel state information, multiple access information and channel quality, which the BS 120 has received from each UE 110, and selects the UEs. When the BS 120 determines the SU-MIMO transmission, it selects one UE. Meanwhile, when the BS 120 determines the MU-MIMO transmission, it compares channel information 330 including two pieces of channel state information, multiple access information and channel quality information, which the BS 120 has received from a UE 110, with channel information 330 including two pieces of channel state information, multiple access information and channel quality information, which the BS 120 has received from another UE 110. Then, the BS 120 selects UEs based on a result of the comparison.

As described above, subband/short-term precoding using channel state information corresponding to the subband/short-term or frequency-selective precoding information may show better performance than that of wideband/long-term precoding using channel state information corresponding to the wideband/long-term precoder information. However, in order to perform the subband/short-term precoding, each UE must frequently feed back much channel state information to the BS, and thus, the feedback of much channel state information may greatly increase feedback overhead.

As described below, the BS 120 configures a precoder so as to have a two-stage structure, and simultaneously performs the wideband/long-term precoding and the subband/short-term precoding. Accordingly, the BS 120 may solve the problems as described above. At this time, the precoder having the two-stage structure frequently receives, as feedback, information on the subband/short-term precoding from each UE, and less frequently receives, as feedback, information on the wideband/long-term precoding from each UE. Accordingly, the precoder having the two-stage structure may reduce feedback overhead, as compared with a precoder having a single structure.

In an environment where the precoder having the two-stage structure is used, in the case of MIMO allowing simultaneous access of an n number of UEs, each UE needs to feed back multiple access information to the BS by using smaller feedback overhead. Particularly, in an environment having a high correlation between antennas, a correlation between downlink channels for each UE 110 needs to predict interference caused by multiple access and set multiple access information, based on the information on the wideband/long-term precoding.

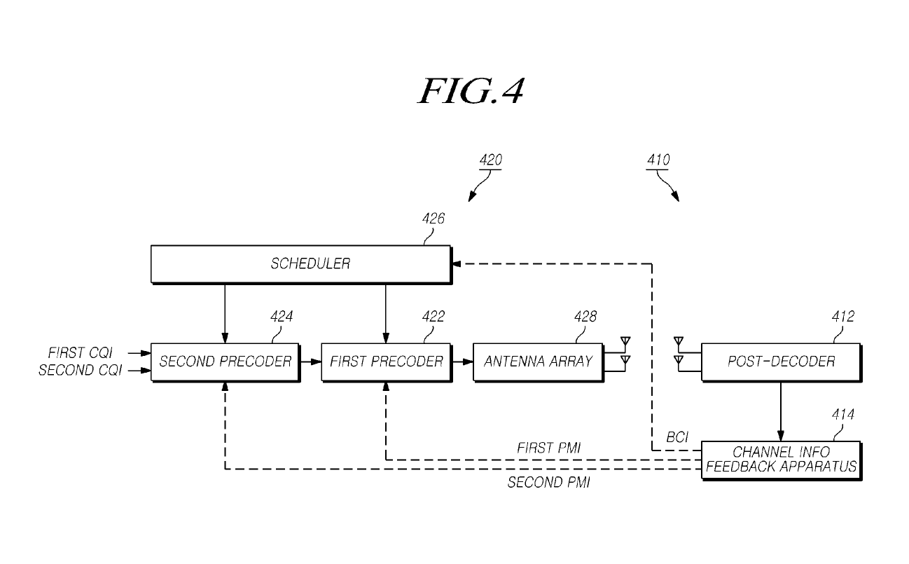

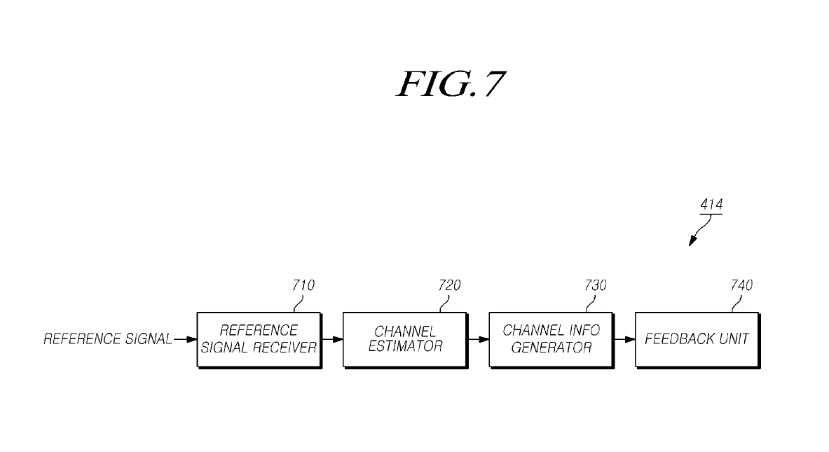

Hereinabove, the process in which the BS and each UE exchange a reference signal and channel information with each other in the wireless communication system, has been described. Hereinafter, the configuration of the BS and that of each UE will be described with reference to FIG. 4 to FIG. 6, and a channel information feedback apparatus according to an embodiment of the present invention in a MIMO system will be described with reference to FIG. 7.

FIG. 4 to FIG. 6 are block diagrams each showing configurations of the base station and each user equipment as shown in FIG. 2 and FIG. 3.

Referring to FIG. 4 to FIG. 6, each UE 410 includes a post-decoder 412 and a channel information feedback apparatus 414. At this time, the channel information feedback apparatus 414 corresponds to an apparatus for transmitting channel information.

The post-decoder 412 processes a received signal, and decodes the processed signal to the original data symbol by using a precoding matrix. The post-decoder 412 is matched to a first precoder 422 and a second precoder 424 of a BS 420. The post-decoder 412 delivers a received reference signal to the channel information feedback apparatus 414.

The channel information feedback apparatus 414 may receive a reference signal, and may estimate a channel by using the received reference signal. The channel information feedback apparatus 414 may generate channel information which includes first channel state information, second channel state information and multiple access information. Meanwhile, the channel information feedback apparatus 414 may feed back the channel information to the BS 420. The channel information feedback apparatus 414 may feed back the first channel state information and the second channel state information to the BS 420 during different cycles, and may feed back the multiple access information to the BS 420 during a cycle or at intervals, which is (are) longer than a shorter feedback cycle or interval among a feedback cycle or interval of the first channel state information and that of the second channel state information.

For example, a channel information feedback apparatus 414 may select a first index (first PMI) of a precoding matrix of each UE itself, which is appropriate for a channel estimated in a particular frequency band, as first channel state information, from a codebook that each UE itself stores therein, and may feed back the selected first index (first PMI) of the precoding matrix to the BS 420, specifically, the first precoder 422, at short feedback intervals. Meanwhile, the channel information feedback apparatus 414 may select a second index (second PMI) of a precoding matrix of each UE itself, which is appropriate for a channel estimated in a wideband or an entire band, as second channel state information, from a codebook that each UE itself stores therein, and may feed back the selected second index (second PMI) of the precoding matrix to the BS 420 at long feedback intervals.

Also, when the BS 420 transmits a signal according to a precoding matrix that each UE itself has reported to the BS, the channel information feedback apparatus 414 may feed back one of information (companion) on precoding of each of the other UEs, which is expected to have a small amount of interference received by each UE, for example, an index (Best Companion Indication, BCI) of a precoding matrix of another UE, which is expected to have the smallest amount of interference, and information (companion) on precoding of each of the other UEs, which is expected to have, in contrast, a large amount of interference received by each UE, for example, an index (Worst Companion Indication, WCI) of a precoding matrix of another UE, which is expected to have the largest amount of interference, as multiple access information, to the BS 420, during a feedback cycle longer than that of the first channel state information having a short feedback cycle, for example, a cycle identical to a feedback cycle of the second channel state information. It goes without saying that the multiple access information has a feedback cycle which is longer than that of the first channel state information and may be longer or shorter than that of the second channel information.

For example, in the case of MIMO allowing simultaneous access of an n number of UEs, each of the n number of UEs 410 may feed back the first channel state information and/or the second channel state information to the BS 420 during different cycles. Each of the n number of UEs 410 may feed back multiple access information on each of an (n−1) number of the other UEs to the BS 420.

Also, the channel information feedback apparatus 414 may measure a channel capacity or a channel quality by using a reference signal, and may report a measured value, as the first channel quality information as described above, to the BS 420. When each UE itself and another UE gain multiple access to the BS 420 by using the first channel state information, the second channel state information and the multiple access information, which the UE itself has reported to the BS 420, the channel information feedback apparatus 414 may calculate a channel capacity or a channel quality, and may report a calculated value, as the second channel quality information as described above, to the BS 420.

Meanwhile, the BS 420 may receive, as feedback, n pieces of first channel state information and/or n pieces of second channel state information, which are reported by the n number of UEs, during different cycles. The BS 420 may receive, as feedback, n×(n−1) pieces of multiple access information, which are reported by the n number of UEs.

Meanwhile, the BS 420 includes a first precoder 422 for precoding data symbols by using a precoding matrix, a second precoder 424, an antenna array 428 for transmitting a precoded signal over the air, and a scheduler 426 for managing the first precoder 422, the second precoder 424, and the antenna array 428.

The first precoder 422 may perform precoding of data symbols based on first channel state information received as feedback from each UE 410, in such a manner that the precoding of the data symbols is adjusted in detail according to time or a band. On the other hand, the second precoder 424 may roughly perform precoding of data symbols based on the location of each UE 410 based on second channel state information received as feedback from each UE 410.

The antenna array 428 uses multiple antennas, and thus, may have an antenna structure, in which a distance between antennas is short and a correlation therebetween is high.

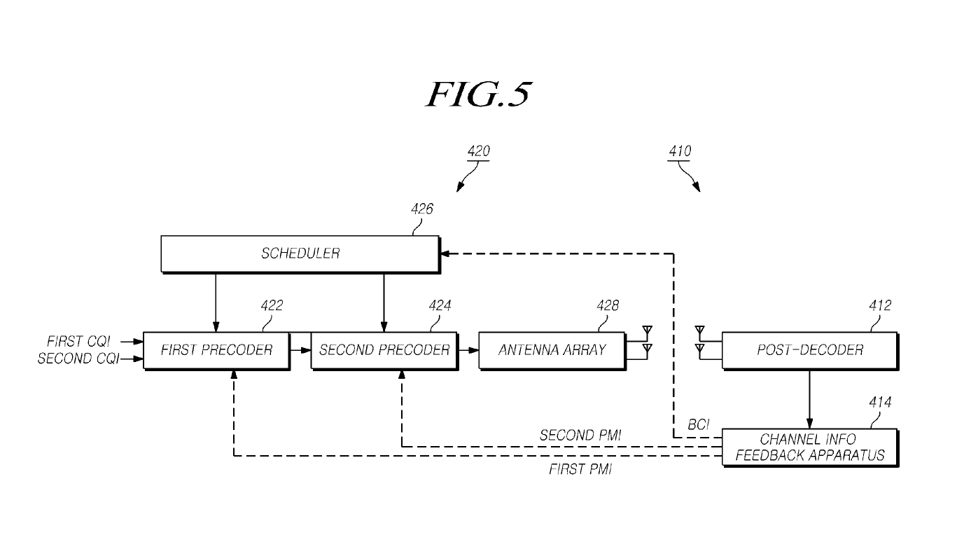

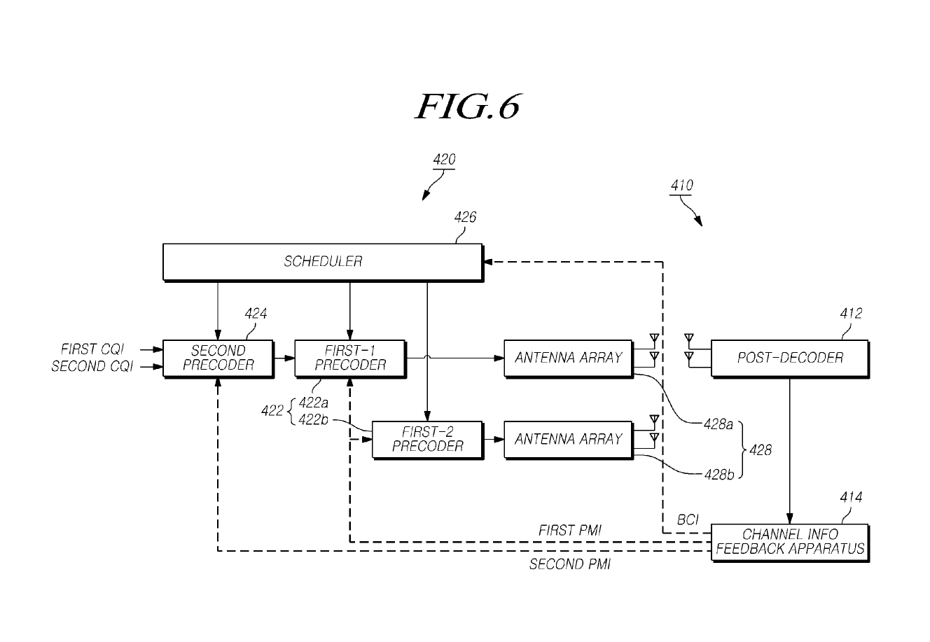

The second precoder 424 may be located before the first precoder 422 as shown in FIG. 4 and FIG. 6, or the first precoder 422 may be located before the second precoder 424 as shown in FIG. 5.

Also, the first precoder 422 may be divided into two first precoders 422a and 422b, as shown in FIG. 6. At this time, the second precoder 424 may control interference between domains caused by a phase mismatch between polarized domains formed by an antenna array in which antenna elements intersect each other horizontally and vertically. The two first precoders 422a and 422b may perform precoding in a domain. At this time, the second precoder 424 serves to control interference between domains caused by a phase mismatch between a polarized domain of the transmission side and a polarized domain of the reception side, and thus, may be a precoder irrelevant to properties of a propagation channel. In this case, the second precoder 424 is irrelevant to whether multiple access interference between UEs occurs, and the use of the second precoder 424 does not affect the control of the multiple access interference. Therefore, multiple access information may be selected in view of only the first precoder 422.

Meanwhile, precoding of the second precoder 424 may be performed by using four codewords, and precoding of the first precoder 422 may be performed by using two codewords. For example, when beam forming-based precoding is performed, the second precoder 424 may perform wideband/long-term beam forming, and the first precoder 422 may perform subband/short-term beam forming.

For example, two UEs which connect to the BS, may both report identical second channel state information to the BS, or may all report identical first channel state information thereto. At this time, the two UEs in the former case both continuously maintain an identical channel state during a predetermined time period, so that they have a high possibility of causing larger mutual interference than in the case of multiple access. In other words, there is a high possibility that the multiple access information will depend largely on the second precoder 424 or the second channel state information. Therefore, when the multiple access information is selected based on the second precoder 424 or the second channel state information regardless of the first precoder 422 or the first channel state information, it is possible to cause feedback overhead to be small without performance degradation.

The scheduler 426 of the BS 420 determines SU-MIMO transmission or MU-MIMO transmission based on channel information including CQIs, two pieces of channel state information and multiple access information, which the BS 420 has received from the channel information feedback apparatus 414 of each UE 410, and selects the UEs. Meanwhile, when the scheduler 426 determines the SU-MIMO transmission, it selects one UE. When the scheduler 426 determines the MU-MIMO transmission, it compares channel information including two pieces of channel state information, multiple access information and channel quality information, which the BS 420 has received from a UE 410, with channel information including two pieces of channel state information, multiple access information and channel quality information, which the BS 420 has received from another UE 410. Then, the scheduler 426 selects UEs based on a result of the comparison.

The scheduler 426 may generate precoding matrixes of the one UE, or the two or more UEs, which has (or have) been selected. The scheduler 426 may provide the two generated precoding matrixes to the first precoder 422 and the second precoder 424, respectively. As a result, the first precoder 422 and the second precoder 424 may precode a data symbol by using the precoding matrixes received from the scheduler 426, respectively.

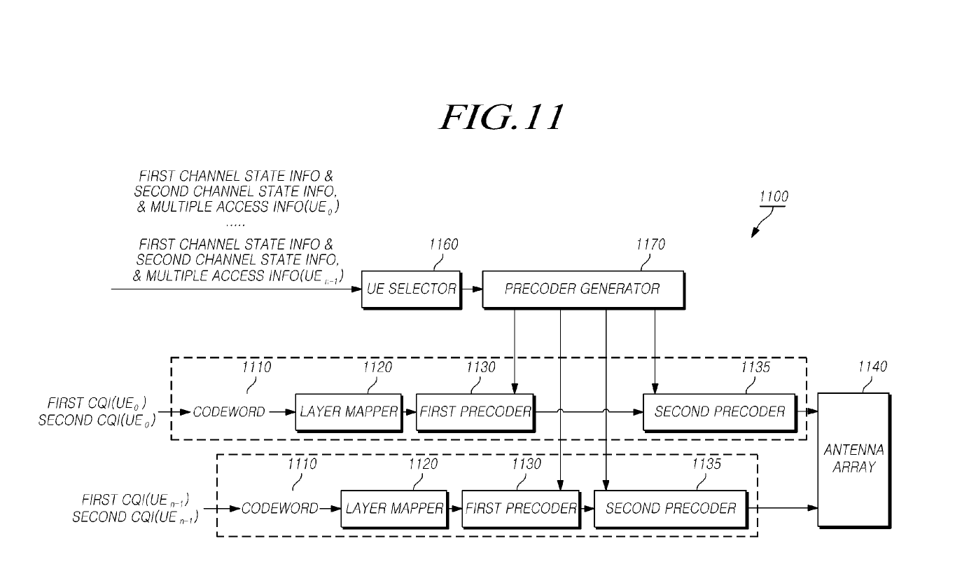

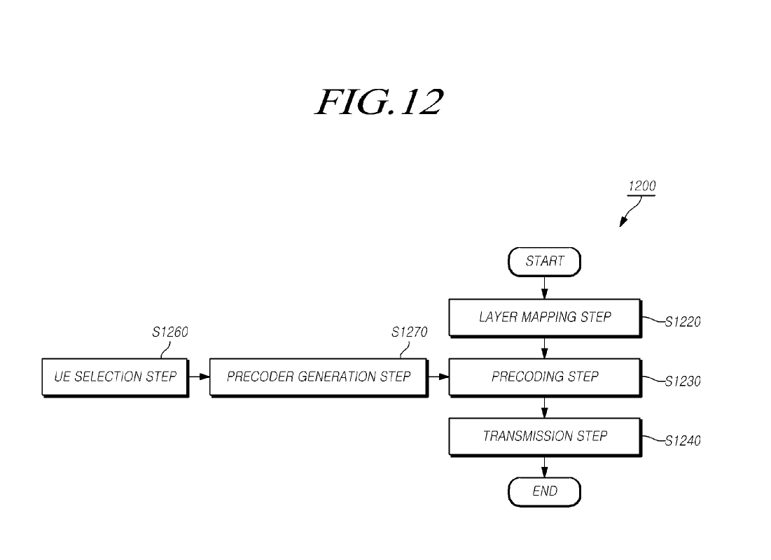

A specific process in which the scheduler 426 selects one of SU/MU-MIMO transmission modes and UEs, will be described in more detail when a BS or a BS apparatus is described below with reference to FIG. 11 and FIG. 12.

FIG. 7 is a block diagram showing each function of a channel information feedback apparatus according to an embodiment of the present invention in a MIMO system.

Referring to FIG. 7, the channel information feedback apparatus 414 may be implemented in hardware or software within an already-connected UE which is currently connected, or within an additionally-connected UE which attempts an additional connection. However, the present invention is not limited to this configuration. Accordingly, the channel information feedback apparatus 414 may also be implemented within a BS, etc.

The channel information feedback apparatus 414 according to an embodiment of the present invention mainly includes: a reference signal receiver 710 for receiving a reference signal, for example, a CSI-RS (Channel State Information-Reference Signal), a CRS (Common Reference Signal) or a DM-RS (Demodulation-Reference Signal), from the BS; a channel estimator 720 for estimating a channel by using the received reference signal; a channel information generator 730 for generating relevant channel information based on a result of estimating the channel by the channel estimator 720; and a feedback unit 740 for feeding back the generated channel information.

In the channel information feedback apparatus 414, the reference signal receiver 710 and the channel estimator 720 may be separately implemented or may be integrated into a single unit. According to circumstances, they may be integrated into a single unit.

Hereinafter, a CSI-RS will be described as an example of a reference signal, but the present invention is not limited to this example. Accordingly, any other reference signal may be used in the present invention.

The reference signal receiver 710 receives a cell-specific CSI-RS, and has information such that a CSI-RS is received in any band (any subcarrier) and any symbol of a received signal. Accordingly, the reference signal receiver 710 may measure a reception value of the CSI-RS by determining a signal in the time-frequency domain.

The CSI-RS is a reference signal that the BS transmits in order to enable each UE to estimate a downlink channel.

The channel estimator 720 estimates a channel by using the received CSI-RS, and the channel is estimated as follows.

A reception value of the CSI-RS received by the reference signal receiver 710 is defined by Equation 1 below. In Equation (1), r̅^{RS} represents the reception value of the received CSI-RS, H represents a propagation channel, t̅^{RS} represents a transmission value of a transmitted CSI-RS, and η̅ represents Gaussian noise.

r̅^{RS}=H t̅^{RS}+ η̅ (1)

In Equation (1), r̅^{RS} corresponding to a reception value of the received CSI-RS may be detected by the measurement as described above, and t̅^{RS} corresponding to a CSI-RS transmission value is a value which is already known between the BS and each UE. Accordingly, H corresponding to a propagation channel may be estimated by using a conventional channel estimation technique. A propagation channel H corresponding to a result of estimating a channel by the channel estimator 720 may be a channel matrix or a covariance matrix.

Also, the channel estimator 720 may estimate a long-term/wideband statistical property of the propagation channel H corresponding to the result of the channel estimation, at regular intervals. For example, the statistical property may be a mean value of channel matrixes during a predetermined time period, or may be a channel correlation matrix R expressed by Equation (2) below.

$$R = E [ \begin{matrix}{\sum }_{m = 1}^{N} {h}_{m} & {h}_{m}^{H}\end{matrix} ] \qquad ( 2 )$$

In Equation (2), E signifies a mean of the product of a channel matrix and a Hermitian matrix, which is formed by the product of the channel matrix and its conjugate-transpose, and N signifies the number of channel matrixes considering a statistical property during a predetermined time period.

Then, the channel information generator 730 may generate first channel state information based on the propagation channel H corresponding to the result of estimating the channel by the channel estimator 720. For example, the channel information generator 730 selects a first index (first PMI) of a precoding matrix of each UE itself, which is appropriate for a propagation channel H estimated in a particular frequency band, as the first channel state information, from a codebook that each UE itself stores therein.

Also, the channel information generator 730 may generate second channel state information based on the statistical property (long-term/wideband statistical property) corresponding to the result of estimating the channel by the channel estimator 720, for example, a channel correlation matrix R. For example, the channel information generator 730 selects a second index (second PMI) of a precoding matrix of each UE itself, which is appropriate for a channel estimated in a wideband or an entire band, as the second channel state information, from a codebook that each UE itself stores therein.

When the BS 420 transmits a signal according to a precoding matrix that each UE itself has reported to the BS, the channel information generator 730 selects either information on precoding of another UE, which is expected to have the smallest amount of interference received by each UE, for example, a third index (BCI) of a precoding matrix of another UE, or information on precoding of another UE, which is expected to have, in contrast, the largest amount of interference received by each UE, for example, a third index (WCI) of a precoding matrix of another UE, as multiple access information, from a codebook.

At this time, when the BS 420 transmits a signal according to a precoding matrix that each UE itself has reported to the BS, the channel information generator 730 preliminarily selects either an index (companion indicator) of at least one precoding matrix of the other UEs, which are expected to have a small amount of interference received by each UE, or an index (companion indicator) of at least one precoding matrix of the other UEs, which are expected to have, in contrast, a large amount of interference received by each UE, as the multiple access information, from the codebook, depending on optional purposes of the wireless communication system.

Also, the channel information generator 730 may measure a channel capacity or a channel quality as first channel quality information by using a reference signal. Also, when each UE itself and another UE gain multiple access to the BS 420 by using the first channel state information, the second channel state information and the multiple access information, which the UE itself has reported to the BS 420, the channel information generator 730 may calculate a channel capacity or a channel quality as second channel quality information.

Hereinabove, the elements of the channel information feedback apparatus according to an embodiment of the present invention in the MIMO system have been described. Hereinafter, a channel information generator corresponding to one of the elements of the channel information feedback apparatus according to an embodiment of the present invention in the MIMO system will be described in detail.

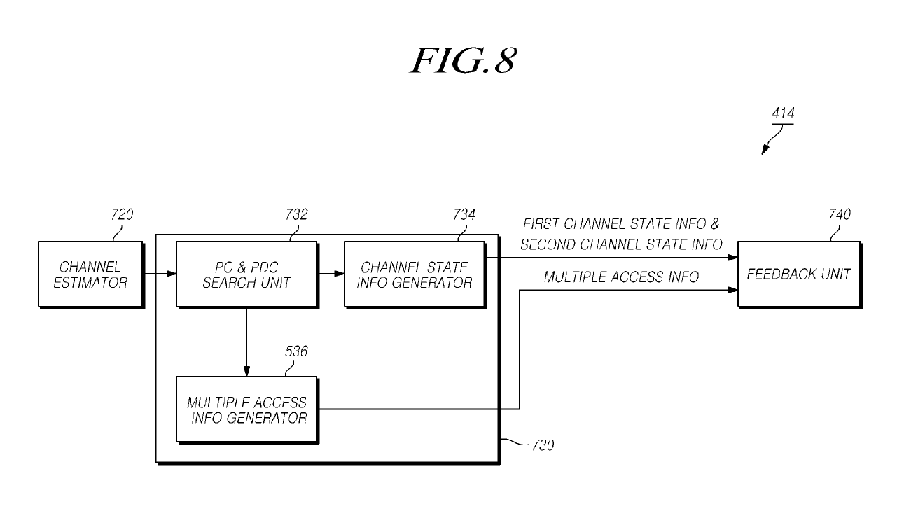

FIG. 8 is a block diagram showing the configuration of a channel information generator as shown in FIG. 7.

The channel information generator 730 includes: a PC-PDC (Precoder and Post-decoder) search unit 732 for searching for an optimal precoder and an optimal post-decoder based on a result of the estimation of the channel estimator 720; a channel state information generator 734 for generating first channel state information and second channel state information based on information on the optimal precoder and post-decoder determined by the PC-PDC search unit 732; and a multiple access information generator 736 for generating multiple access information.

The PC-PDC search unit 732 may search for an optimal precoder and an optimal post-decoder based on the result of the estimation of the channel estimator 720, and may determine an optimal precoding scheme or an optimal precoder, and an optimal post-decoding scheme or an optimal post-decoder, by using various precoding techniques.

The PC-PDC search unit 732 may search for optimal first precoder information based on a propagation channel estimated by the channel estimator 720, and may estimate a first post-decoder based on the found first precoder information. Also, the PC-PDC search unit 732 may search for optimal second precoder information based on a statistical property (long-term/wideband statistical property) estimated by the channel estimator 720, and may estimate a second post-decoder based on the found second precoder information.

The PC-PDC search unit 732 may determine an optimal precoder and an optimal post-decoder through a search for a precoder codebook, for example, as prescribed in 3GPP LTE. However, the present invention is not limited to this configuration. Accordingly, another technique for designing precoding may also be used in the present invention.

The channel state information generator 734 generates first channel state information including a first PMI (Precoding Matrix Indicator) corresponding to the first index of the precoding matrix as described above, based on at least one of the first precoder information and the first post-decoder, which have been estimated by the PC-PDC search unit 732.

Also, the channel state information generator 734 generates second channel state information including a second PMI (Precoding Matrix indicator) corresponding to the second index of the precoding matrix as described above, based on at least one of the second precoder information and the second post-decoder, which have been estimated by the PC-PDC search unit 732.

Also, the channel state information generator 734 may generate a first CQI (Channel Quality Indicator) corresponding to an index matched to the channel quality measured as the first channel quality information as described above. In other words, the channel state information generator 734 may generate the measured channel quality itself as the first channel quality information, but may cause the amount of information to become large. Therefore, the channel state information generator 734 may quantize the measured channel quality, and may generate a first CQI matched to the quantized channel quality, as the first channel quality information.

The multiple access information generator 736 generates the multiple access information as described above, based on both the statistical property (long-term/wideband statistical property) estimated by the channel estimator 720 and the second precoder information and the second post-decoder, which have been estimated by the PC-PDC search unit 732.

For example, the multiple access information generator 736 may generate an index (BCI) of information on precoding of another UE which has the smallest amount of interference received by each UE when the BS transmits a signal according to a precoding matrix indicated by the second PMI as described above. The generation of a BCI is expressed by Equation (3) below.

$$BCI = {min}_{n} [ \vert {CW}_{n} \vert ] \qquad ( 3 )$$

In Equation (3), C signifies a precoding matrix indicated by a wideband/long-term second PMI, namely, second precoder information, and Wₙ signifies information on precoding of another UE, namely, another precoding matrix indexed by n.

As defined by Equation (3), an index n having the smallest absolute value of the product of the precoding matrix indicated by the second PMI, namely, the second precoder information, and another precoding matrix indexed by n, is generated as a BCI.

As another example, the multiple access information generator 736 may generate an index of a precoding matrix showing a minimum precoding gain, as a BCI, by using the second precoder information and second post-decoder information. Another example as described above is expressed by Equation (4) below.

$$BCI = {min}_{n} [ \vert {PCW}_{n} \vert ] \qquad ( 4 )$$

In Equation (4), C signifies a precoding matrix indicated by a wideband/long-term second PMI, namely, second precoder information, Wₙ signifies information on precoding of another UE, namely, another precoding matrix indexed by n, and P signifies post-decoder information found based on the second precoder information.

As defined by Equation (4), an index n having the smallest absolute value of the product of the second post-decoder information, the second precoder information and another precoding matrix indexed by n, is generated as a BCI.

BCI may refer to a factor of a codeword showing the smallest precoding gain for both a channel, for which the use of a second PMI is determined, and a post-decoder matched to the second PMI. Therefore, BCI may be an index designating a precoding matrix having the smallest similarity to a precoding matrix indicated by the second PMI. For example, the similarity may signify a distance between matrixes or a mutual relation or correlation between matrixes. Namely, the precoding matrix having the smallest similarity may signify a precoding matrix having a large chordal distance between itself and a precoding matrix indicated by the second PMI, and may also signify a precoding matrix having the smallest correlation between itself and the precoding matrix indicated by the second PMI.

In contrast, the multiple access information generator 736 may generate an index (WCI) of information on precoding of another UE which has the largest amount of interference received by each UE when the BS transmits a signal according to the second PMI as described above. In other words, the multiple access information generator 736 may generate, as WCI, an index n having the largest absolute value of the product of the precoding matrix indicated by the second PMI, namely, the second precoder information, and another precoding matrix indexed by n as defined by Equation (5) below, in contrast to the process for generating a BCI as described above. Otherwise, the multiple access information generator 736 may generate, as WCI, an index n having the largest absolute value of the product of the second post-decoder information, the second precoder information and another precoding matrix indexed by n as defined by Equation (6) below, in contrast to the process for generating a BCI as described above.

$$\begin{matrix}WCI = {max}_{n} [ \vert {CW}_{n} \vert ] & ( 5 ) \\ WCI = {max}_{n} [ \vert {PCW}_{n} \vert ] & ( 6 )\end{matrix}$$

When each UE itself and another UE gain multiple access to the BS 420 by using the second channel quality information as described above, the multiple access information generator 736 may generate a second CQI (also referred to as a “delta-CQI”) corresponding to an index matched to channel quality of each UE. For the same reason as the reason described in relation to the first channel quality information, when each UE itself and another UE gain multiple access to the BS 420, the channel state information generator 734 may generate channel quality itself of each UE as second channel quality information. However, in order to cause the amount of information to be small, the channel state information generator 734 may quantize the calculated channel quality, and may generate a second CQI matched to the quantized channel quality, as second channel quality information.

The second CQI notifies the BS of a reduction in channel quality, which results from switching from SU-MIMO to MU-MIMO. The BS may determine the selection of one of SU/MU-MIMO modes and an information reception rate of each UE during MU-MIMO, based on the second CQI.

When a single precoder is used, a second CQI may be measured in the following method.

An expected interference of a UE UEₙ may be expressed by Iₙ=∥PₙHQₙ∥. At this time, Fₙ represents a post-decoder or a post-decoding matrix matched to a precoding matrix of the UE UEₙ, namely, a matrix for performing receiver filtering; Qₙ represents multiple access information reported by the UE UEₙ, for example, a precoding matrix matched to a BCI; H represents a propagation channel; and ∥X∥ represents the sum of power of elements of a matrix X.

An expected SINR (Signal to Interference and Noise Ratio) of the UE UEₙ in the case of MU-MIMO may be expressed by Equation (7) below.

$$\frac{dia ( {F}_{n} {HW}_{n} )}{‖ {F}_{n} {HW}_{n} ‖ - dia ( {F}_{n} {HW}_{n} ) + {I}_{n} + {σ}_{η}^{2}} \qquad ( 7 )$$

At this time, H represents a propagation channel, Wₙ represents a precoding matrix matched to a BCI reported by the UE UEₙ, σ_{η} represents a noise component, and dia(X) represents the sum of power of diagonal elements of a matrix X.

Therefore, the second CQI may be expressed by Equation (8) below.

$$\frac{dia ( {F}_{n} {HW}_{n} )}{‖ {F}_{n} {HW}_{n} ‖ - dia ( {F}_{n} {HW}_{n} ) + {σ}_{η}^{2}} - \frac{dia ( {F}_{n} {HW}_{n} )}{‖ {F}_{n} {HW}_{n} ‖ - dia ( {F}_{n} {HW}_{n} ) + {I}_{n} + {σ}_{η}^{2}} \qquad ( 8 )$$

At this time, H represents a propagation channel, Wₙ represents a precoding matrix matched to a BCI reported by the UE UEₙ, σ_{η} represents a noise component, and dia(X) represents the sum of power of diagonal elements of a matrix X.

Meanwhile, when multiple access information is selected in view of only one precoder, namely, the first precoder 422 or the second precoder 424 in a case where the BS uses the precoders 422 and 424 having a two-stage structure as shown in FIG. 4 to FIG. 6, in order to measure a second CQI, a precoding matrix related to multiple access information on the other precoder must be assumed.

As shown in FIG. 4 and FIG. 5, the first precoder 422 may affect multiple access interference (MAI), but the effect is not significant. Accordingly, on the assumption that a UE reported by a BCI uses the first precoder 422 identical to that of the UE UEₙ, the UE reported by the BCI may measure a second CQI.

When the first precoder 422 does not affect multiple access interference (MAI) as shown in FIG. 6, a second CQI may be measured on the assumption that the first precoder 422 is an optional unit. At this time, on the assumption that a UE reported by a BCI uses the first precoder 422 identical to that of the UE UEₙ, the UE reported by the BCI may generate Qₙ, and may measure the second CQI.

Referring again to FIG. 7, the feedback unit 740 may feed back channel information, which the channel information generator 730 has generated, to the BS 420. The feedback unit 740 may feed back first channel state information and second channel state information to the BS 420 during different cycles. Also, the feedback unit 740 may feed back multiple access information to the BS 420 during a cycle or at intervals, which is (or are) longer than a shorter feedback cycle or interval among a feedback cycle or interval of the first channel state information and that of the second channel state information.

For example, the feedback unit 740 may feed back a first index (first PMI) of a precoding matrix of each UE itself, which is appropriate for a channel estimated in a particular frequency band, as the first channel state information, to the BS 420, specifically, the first precoder 422, at short feedback intervals. Meanwhile, the feedback unit 740 may feed back a second index (second PMI) of a precoding matrix of each UE itself, which is appropriate for a channel estimated in a wideband or an entire band, as the second channel state information, to the BS 420 at long feedback intervals.

Also, the feedback unit 740 may feed back one of a BCI or a WCI corresponding to a third index, as the multiple access information, to the BS 420 during a feedback cycle longer than that of the first channel state information having a short feedback cycle, for example, a cycle identical to a feedback cycle of the second channel state information.

Also, the feedback unit 740 may report the first CQI measured by the channel state information generator 734 and the multiple access information generator 736, and/or the second CQI calculated by the channel state information generator 734 and the multiple access information generator 736, as channel capacity or channel quality, to the BS 420.

Hereinabove, the channel information feedback (transmission) apparatus according to an embodiment of the present invention in the MIMO system, has been described. Hereinafter, a method for feeding back (transmitting) channel information according to an embodiment of the present invention in the MIMO system, will be described.

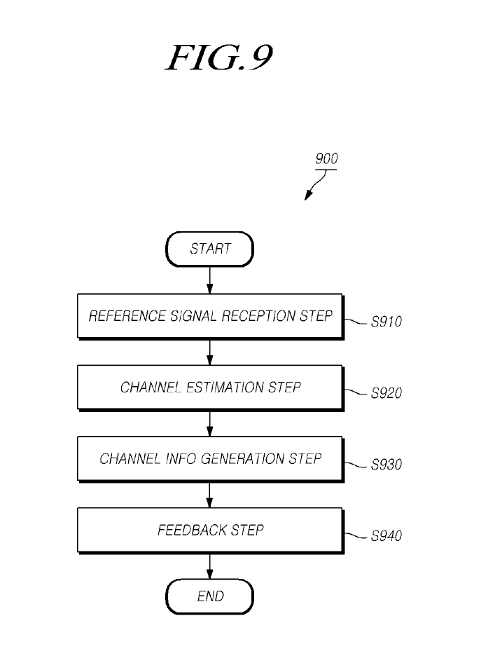

FIG. 9 is a flowchart showing a method for feeding back (transmitting) channel information according to another embodiment of the present invention in a MIMO system.

A method 900 for feeding back (transmitting) channel information in MU-MIMO according to another embodiment of the present invention includes: reference signal reception step S910 of receiving a reference signal, for example, a CSI-RS (Channel State Information-Reference Signal), a CRS (Common Reference Signal) or a DM-RS (Demodulation-Reference Signal), from the BS; channel estimation step S920 of estimating a channel by using the received reference signal; channel information generation step S930 of generating relevant channel information based on a result of estimating the channel in channel estimation step S920; and feedback step S940 of feeding back the generated channel information.

In the method 900 for feeding back (transmitting) channel information, reference signal reception step S910 and channel estimation step S920 may be separately implemented or may be integrated into a single step. According to circumstances, they may be integrated into a single step.

In reference signal reception step S910, a cell-specific CSI-RS is received, and information such that a CSI-RS is received in any band (any subcarrier) and any symbol of a received signal is held. Accordingly, a reception value of the CSI-RS may be measured by determining a signal in the time-frequency domain.

In channel estimation step S920, a channel is estimated by using the received CSI-RS, and the channel is estimated as follows. A reception value of the CSI-RS received in reference signal reception step S910 is defined by Equation 1 above. r̅^{RS} corresponding to a reception value of the received CSI-RS may be detected by the measurement as described above, and t̅^{RS} corresponding to a CSI-RS transmission value is a value which is already known between the BS and each UE. Accordingly, H corresponding to a propagation channel may be estimated by using a conventional channel estimation technique.

Also, in channel estimation step S920, a long-term/wideband statistical property of the propagation channel H corresponding to a result of estimating a channel may be estimated at regular intervals. For example, the statistical property may be a mean value of channel matrixes during a predetermined time period, or may be a channel correlation matrix R expressed by Equation (2) above.

Then, in channel information generation step S930, channel information is generated based on the result of estimating the channel in channel estimation step S920. As described above, the channel information includes first channel state information and second channel state information on each UE itself, and multiple access information on another UE due to multiple access determined by each UE itself or interference information due to the multiple access.

Hereinabove, some steps of the method for feeding back channel information according to an embodiment of the present invention in the MIMO system have been described. Hereinafter, examples of a channel information generation step corresponding to one of steps of the method for feeding back channel information according to an embodiment of the present invention in the MIMO system will be described.

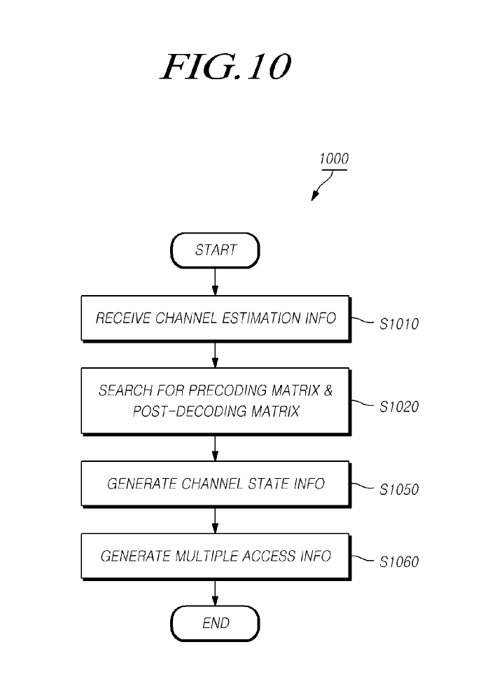

FIG. 10 is a flowchart showing an example of a method for generating channel information according to still another embodiment of the present invention.

A method 1000 for generating channel information as shown in FIG. 10 corresponds to a part of channel information generation step S930 as described above, and may also configure an independent method. In other words, the method 1000 for generating channel information as shown in FIG. 10 may configure a method independent of steps before and after channel information generation step S930 as shown in FIG. 9. Therefore, the method 1000 for generating channel information may be included in order to implement another technology.

Referring to FIG. 9 and FIG. 10, an estimated propagation channel and an estimated long-term/wideband statistical property which are the results of estimating the channel in channel estimation step S920, are received as input (S1010). The estimated propagation channel and the long-term/wideband statistical property may be the same as described above with reference to Equations 1 and 2.

Then, a search may be made for an optimal precoder and an optimal post-decoder based on the input propagation channel and the input long-term/wideband statistical property, and an optimal precoding scheme or precoder (PC) and an optimal post-decoding scheme or post-decoder (PDC) may be determined by using various precoding techniques (S1010).

Specifically, in step S1020, a search may be made for optimal first precoder information based on the propagation channel estimated in channel estimation step S920, and a first post-decoder may be estimated based on the found first precoder information. Also, in step S1020, a search may be made for optimal second precoder information based on the long-term/wideband statistical property estimated in channel estimation step S920, and a second post-decoder may be estimated based on the found second precoder information.

Then, first channel state information including a first PMI (Precoding Matrix Indicator) corresponding to the first index of the precoding matrix as described above, is generated based on the first precoder information and the first post-decoder which have been estimated in step S1020 (S1050). Specifically, as described above, when a codebook is searched for the precoding matrix estimated in step S1020 and the precoding matrix is determined, a first PMI (Precoding Matrix Indicator) of the precoding matrix is generated in step S1050. Also, when the codebook is searched for the precoding matrix estimated in step S1020 and the precoding matrix is determined, a second PMI (Precoding Matrix Indicator) corresponding to a second index of the precoding matrix is generated in step S1050.

In step S1050, a first CQI (Channel Quality Indicator) related to channel quality of each UE itself may be generated.

Then, the multiple access information as described above is generated based on the propagation channel and the long-term/wideband statistical property which have been estimated in channel estimation step S920, and based on the first precoder information, the second precoder information, the first post-decoder and the second post-decoder which have been estimated in step S1020 (S1060).

For example, in step S1060, an index (BCI) of information on precoding of another UE, which has the smallest amount of interference received by each UE when the BS transmits a signal according to a precoding matrix indicated by the second PMI as described above, may be generated as expressed by Equation (3). Namely, as defined by Equation (3), an index n having the smallest absolute value of the product of the precoding matrix indicated by the second PMI, namely, the second precoder information, and another precoding matrix indexed by n, may be generated as a BCI.

As another example, as defined by Equation (4), an index of a precoding matrix showing a minimum precoding gain may be generated as a BCI corresponding to a third index by using the second precoder information and second post-decoder information. Namely, as defined by Equation (4), an index n having the smallest absolute value of the product of the second post-decoder information, the second precoder information and another precoding matrix indexed by n, may be generated as a BCI.

In contrast, in step S1060, an index (WCI) of information on precoding of another UE, which has the largest amount of interference received by each UE when the BS transmits a signal according to the second PMI, may be generated as described above with reference to Equation (5) or (6).

In step S1060, when each UE itself and another UE gain multiple access to the BS 420, a second CQI corresponding to information related to channel quality may be generated as described above with reference to Equation (7) and (8).

Referring again to FIG. 9, in feedback step S940, channel information including the first channel state information and the second channel state information, and the multiple access information as described above is fed back to the BS. In the case of MIMO allowing simultaneous access of an n number of UEs, the channel information fed back by each UE in feedback step 5940 may include multiple access information including first channel state information and second channel state information, which include a PMI of each UE, and an (n−1) number of BCIs (or WCIs).

In feedback step S940, the first channel state information and the second channel state information may be fed back to the BS 420 during different cycles, and the multiple access information may be fed back to the BS 120 at intervals, each of which is longer than a shorter feedback interval among a feedback interval of the first channel state information and that of the second channel state information.

Also, in feedback step S940, one of a BCI and a WCI may be fed back, as the multiple access information, to the BS 420 during a feedback cycle longer than that of the first channel state information having a short feedback cycle, for example, a cycle identical to a feedback cycle of the second channel state information.

Also, in feedback step S940, the first CQI measured as channel capacity or channel quality, and/or the second CQI calculated as the channel capacity or channel quality may be reported to the BS.

Hereinabove, the method for feeding back (transmitting) channel information according to an embodiment of the present invention in the MIMO system has been described. Hereinafter, a BS according to yet another embodiment of the present invention will be described.

FIG. 11 is a block diagram showing the configuration of a BS according to yet another embodiment of the present invention.

The BS or BS apparatus 1100 includes a layer mapper 1120 for mapping a codeword 1110 to a layer, a first precoder 1130 and a second precoder 1135 for precoding data symbols, and an antenna array 1140 including two or more antennas for propagating the precoded symbol over the air. Each of the layer mapper 1120, the first precoder 1130 and the second precoder 1135, and the antenna array 1140 has a configuration identical or substantially identical to a current or future general configuration. Accordingly, a detailed description thereof will be omitted.

The BS 1100 precodes data symbols by using two precoders, namely, the first precoder 1130 and the second precoder 1135. At this time, each of the first precoder 1130 and the second precoder 1135 may precode a data symbol by using a precoding matrix thereof.

Each UE delivers channel information, which includes first channel state information, second channel state information and multiple access information, to the BS 1100 in the method as described above. Also, each UE may measure a channel capacity or a channel quality by using a reference signal, and may report the measured value to the BS 1100 through a first CQI. When each UE and another UE have gained multiple access to the BS 1100, each UE may calculate a channel quality, and may report the calculated value to the BS 1100 through a second CQI.

Also, the BS 1100 includes a UE selector 1160 and a precoder generator 1170. At this time, the UE selector 1160 and the precoder generator 1170 may be a part of the scheduler 426 as shown in FIG. 4 to FIG. 6, or may be an element separate from the scheduler 426. Therefore, the following description related to the UE selector 1160 and the precoder generator 1170 may correspond to a description related to the scheduler 426 as shown in FIG. 4 to FIG. 6.

The UE selector 1160 determines SU-MIMO transmission or MU-MIMO transmission and selects the UEs, based on channel information including CQIs, first channel state information, second channel state information and multiple access information which have been received from each UE. When the UE selector 1160 determines the SU-MIMO transmission, it selects one UE. Meanwhile, when the UE selector 1160 determines the MU-MIMO transmission, it first compares channel information including CQIs, first channel state information, second channel state information and multiple access information which have been received from a UE with channel information including CQIs, first channel state information, second channel state information and multiple access information which have been received from another UE, and then detects a correlation between channels of the UEs. The UE selector 1160 selects UEs satisfying a particular condition based on the correlation between the channels of the UEs. At this time, the UEs satisfying the particular condition may signify UEs having the smallest channel interference between the UEs. However, the present invention is not limited to this configuration.

For example, in the case of MIMO allowing simultaneous access of an n number of UEs, channel information may include an n number of first PMIs and an n number of second PMIs, which are included in multiple pieces of channel state information received from the n number of UEs, and an n×(n−1) number of BCIs included in multiple pieces of multiple access information received from the n number of UEs. Also, the BS 1100 may receive an n number of first CQIs and an n number of second CQIs from the n number of UEs.

At this time, when a precoding matrix designated by a PMI of each UE coincides with one of precoding matrixes designated by BCIs of the other UEs, the UE selector 1160 may determine MU-MIMO transmission of the UE and one or more the other UEs. For example, when a wideband/long-term second PMIₙ received from a UE UEₙ coincides with a wideband/long-term BCIₘ received from another UE UEₘ and a wideband/long-term BDIₙ received from the UE UEₙ from coincides with a wideband/long-term second PMIₘ received from another UE UEₘ, the BS allows simultaneous access of the UE UEₙ and the UE UEₘ in a MU-MIMO mode. The relation as described above may be expressed by Equation (9) below.

second PMIₙ=BCIₘ BCI_{n=second} PMIₘ (9)

In other words, in a case where the UE UEₙ and the UE UEₘ all use an identical codebook for a PMI and a BCI, when the UE UEₙ transmits a second PMI matched to a seventh codeword of a particular codebook and a BCI matched to a fourth codeword thereof, and when the UE UEₘ transmits a second PMI matched to the fourth codeword of the particular codebook and a BCI matched to the seventh codeword thereof, the BS may allow simultaneous access of the UE UEₙ and the UE UEₘ.

Meanwhile, the UE selector 1160 may select a MU-MIMO mode operation and UEs in view of the first CQI and the second CQI received from each of the UE and one or more the other UEs, which have been determined. For example, when one or both of the first CQI and the second CQI are less than a threshold, the UE selector 1160 does not operate in a MU-MIMO mode, but may determine transmission in a SU-MIMO mode. Meanwhile, the UE selector 1160 may determine one of SU/MU-MIMO modes according to a scheduling algorithm. For example, although a scheduling algorithm satisfies the conditions as described above when throughput maximization is the scheduling algorithm, the UE selector 1160 may select a mode which supports a higher transmission rate among the SU/MU-MIMO modes.

As another example, in the case of MIMO allowing simultaneous access of an n number of UEs, channel information includes an n number of first PMIs and an n number of second PMIs, which are included in multiple pieces of channel state information received from the n number of UEs, and an n×(n−1) number of WCIs included in multiple pieces of multiple access information received from the n number of UEs. Also, the BS 1100 may receive an n number of first CQIs and an n number of second CQIs from the n number of UEs.

When a precoding matrix designated by a PMI of each UE coincides with one of precoding matrixes which are not designated by WCIs of the other UEs, the UE selector 1160 may determine MU-MIMO transmission of the UE and one or more the other UEs. At this time, as described above, the UE selector 1160 may select a transmission mode and UEs by simultaneously or individually considering the first CQI, the second CQI and the scheduling algorithm.

The precoder generator 1170 generates a precoding matrix of the one UE or precoding matrixes of the two or more UEs, which the UE selector 1160 has selected. At this time, the precoder generator 1170 generates a precoding matrix of the one UE, or precoding matrixes of the two or more UEs based on channel information received from each of the UEs selected by the UE selector 1160, for example, PMIs and BCIs of the selected UEs.

Hereinabove, the BS according to yet another embodiment of the present invention has been described. Hereinafter, a transmission method of the BS according to yet another embodiment of the present invention will be described.

FIG. 12 is a flowchart showing a method for transmitting a signal by the BS according to yet another embodiment of the present invention.

Referring to FIG. 12, a transmission method 1200 of the BS according to yet another embodiment of the present invention includes: layer mapping step S1220 of mapping a codeword to a layer; precoding step S1230 of precoding symbols; and transmission step S1240 of propagating the precoded symbol over the air through two or more antennas. Each of layer mapping step S1220, precoding step S1230 and transmission step S1240 has a configuration identical or substantially identical to a current or future general configuration. Accordingly, a detailed description thereof will be omitted.

In step S1240, data symbols may be precoded by using the two precoders, namely, by using one precoding matrix of each of the two precoders.

Also, the transmission method 1200 of the BS according to yet another embodiment of the present invention includes UE selection step S1260 and precoder generation step S1270.

In UE selection step S1260, SU-MIMO transmission or MU-MIMO transmission is determined and the UEs are selected, based on channel information including CQIs, first channel state information, second channel state information and multiple access information which have been received from each UE. In UE selection step S1260, when the SU-MIMO transmission is determined, one UE is selected. Meanwhile, in UE selection step S1260, when the MU-MIMO transmission is determined, a comparison is first made between channel information including CQIs, first channel state information, second channel state information and multiple access information which have been received from a UE, and channel information including CQIs, first channel state information, second channel state information and multiple access information which have been received from another UE, and then a correlation between channels of the UEs is detected.

Specifically, in UE selection step S1260, precoding matrixes designated by BCIs of the other UEs may be determined based on a particular codebook, as described above in relation to the UE selector 1160. In contrast, in UE selection step S1260, precoding matrixes which are not designated by WCIs of the other UEs, may be determined based on a particular codebook. Meanwhile, in UE selection step S1260, a transmission mode and UEs may be selected in view of the CQIs and a scheduling algorithm, as described above.

In precoder generation step S1270, a precoding matrix of the one UE or precoding matrixes of the UEs, which have been selected in UE selection step S1260, are generated. At this time, in precoder generation step S1270, a precoding matrix of the one UE, or precoding matrixes of the UEs are generated based on channel information received from each of the UEs selected in UE selection step S1260.

Hereinabove, although the embodiments of the present invention have been described in detail with reference to the accompanying drawings, the present invention is not limited to the embodiments of the present invention.

The embodiments of the present invention as described above may be applied to uplink/downlink MIMO systems, and may be applied not only to a single cell environment but also to all uplink/downlink MIMO systems, such as a coordinated multi-point transmission/reception system (CoMP) and a heterogeneous network.

The above description is only an illustrative description of the technical idea of the present invention, and those having ordinary knowledge in the technical field, to which the present invention pertains, will appreciate that various changes and modifications may be made to the embodiments described herein without departing from the essential features of the present invention. Therefore, the embodiments disclosed in the present invention are intended not to limit but to describe the technical idea of the present invention, and thus do not limit the scope of the technical idea of the present invention. The protection scope of the present invention should be construed based on the appended claims, and all of the technical ideas included within the scope equivalent to the appended claims should be construed as being included within the right scope of the present invention.

1. A method for receiving channel information by a base station, the method comprising:
receiving, as feedback, first channel state information and second channel state information from at least one user equipment during different cycles; and
receiving, as feedback, multiple access information of at least one user equipment different from the user equipment during a cycle longer than a shorter cycle among a cycle of the first channel state information and a cycle of the second channel state information, when simultaneous access of the user equipment and the different user equipment is allowed.

2. The method as claimed in claim 1, wherein the first channel state information corresponds to a first index of a precoding matrix of the user equipment having a short feedback cycle, the second channel state information corresponds to a second index of a precoding matrix of the user equipment having a long feedback cycle, and the multiple access information corresponds to a third index of a precoding matrix of the different user equipment.

3. The method as claimed in claim 1, wherein one of the first channel state information and the second channel state information is received as feedback during a cycle identical to a cycle, during which the multiple access information is received as feedback.

4. The method as claimed in claim 2, further comprising receiving, as feedback, information related to calculated channel quality from the user equipment, when precoding is performed with respect to the user equipment itself by using a precoding matrix matched to one of the first index and the second index and precoding is performed with respect to the different user equipment by using a precoding matrix matched to the third index while the user equipment itself and the different user equipment gain multiple access.

5. The method as claimed in claim 2, wherein the second index corresponds to an index of a precoding matrix of the user equipment selected based on a statistical property during a predetermined time period.

6. The method as claimed in claim 2, wherein the third index corresponds to an index of information on precoding of the different user equipment having a large or small amount of interference received by each user equipment when a signal is transmitted according to the second index.

7. A method for transmitting channel information by a user equipment, the method comprising:
estimating a channel with reference to a reference signal received from a base station;
generating channel information including first channel state information, second channel state information, and multiple access information of at least one user equipment different from a user equipment in a case where simultaneous access of the user equipment and the different user equipment is allowed, by using the estimated channel; and
feeding back the first channel state information and the second channel state information to the base station during different cycles, and feeding back the multiple access information to the base station during a cycle longer than a shorter cycle among a cycle of the first channel state information and a cycle of the second channel state information.

8. The method as claimed in claim 7, wherein the first channel state information corresponds to a first index of a precoding matrix of the user equipment having a short feedback cycle, the second channel state information corresponds to a second index of a precoding matrix of the user equipment having a long feedback cycle, and the multiple access information corresponds to a third index of a precoding matrix of the different user equipment.

9. The method as claimed in claim 7, wherein one of the first channel state information and the second channel state information is fed back during a cycle identical to a cycle, during which the multiple access information is fed back.

10. The method as claimed in claim 8, wherein, in generating of the channel information, information related to calculated channel quality is generated when precoding is performed with respect to the user equipment itself by using a precoding matrix matched to the second index and precoding is performed with respect to the different user equipment by using a precoding matrix matched to the third index while the user equipment itself and the different user equipment gain multiple access; and
wherein, in feeding back of the channel information, the information related to the channel quality is fed back to the base station.

11. The method as claimed in claim 8, wherein the second index corresponds to an index of a precoding matrix of the user equipment selected based on a statistical property during a predetermined time period.

12. The method as claimed in claim 8, wherein the third index corresponds to an index of a precoding matrix of the different user equipment having a large or small amount of interference received by each user equipment when a signal is transmitted according to the second index.

13. An apparatus for transmitting channel information, the apparatus comprising:
a channel estimator for estimating a channel by using a reference signal received from a base station;
a channel information generator for generating channel information including first channel state information, second channel state information, and multiple access information of at least one user equipment different from a user equipment in a case where simultaneous access of the user equipment and the different user equipment is allowed, by using the estimated channel; and
a feedback unit for feeding back the first channel state information and the second channel state information to the base station during different cycles, and feeding back the multiple access information during a cycle longer than a shorter cycle among a cycle of the first channel state information and a cycle of the second channel state information.

14. The apparatus as claimed in claim 13, wherein the first channel state information corresponds to a first index of a precoding matrix of the user equipment having a short feedback cycle, the second channel state information corresponds to a second index of a precoding matrix of the user equipment having a long feedback cycle, and the multiple access information corresponds to a third index of a precoding matrix of the different user equipment.

15. The apparatus as claimed in claim 13, wherein one of the first channel state information and the second channel state information is fed back during a cycle identical to a cycle, during which the multiple access information is fed back.

16. The apparatus as claimed in claim 14, wherein the channel information generator generates information related to calculated channel quality when precoding is performed with respect to the user equipment itself by using a precoding matrix matched to the second index and precoding is performed with respect to the different user equipment by using a precoding matrix matched to the third index while the user equipment itself and the different user equipment gain multiple access; and
wherein the feedback unit feeds back the information related to the channel quality to the base station.

17. The apparatus as claimed in claim 14, wherein the second index corresponds to an index of a precoding matrix of the user equipment selected based on a statistical property during a predetermined time period.

18. The apparatus as claimed in claim 14, wherein the third index corresponds to an index of a precoding matrix of the different user equipment having a large or small amount of interference received by each user equipment when a signal is transmitted according to the second index.

19. A base station comprising:
a layer mapper for mapping a codeword to a layer;
first and second precoders for receiving, as feedback, first channel state information and second channel state information from at least one user equipment during different cycles, and precoding mapped symbols by using precoding matrixes thereof;
a scheduler for receiving, as feedback, multiple access information of at least one user equipment different from the user equipment during a cycle longer than a shorter cycle among a cycle of the first channel state information and a cycle of the second channel state information when the user equipment allows simultaneous access of the user equipment and the different user equipment, selecting a user equipment which is to receive data, and generating precoding matrixes of the first and second precoders; and
an antenna array including two or more antennas for propagating a precoded symbol over the air.

20. A transmission method by a base station, the transmission method comprising:
mapping a codeword to a layer;
selecting a user equipment which is to receive data, after receiving, as feedback, first channel state information and second channel state information of a user equipment during different cycles and receiving, as feedback, multiple access information of at least one user equipment different from the user equipment during a cycle longer than a shorter cycle among a cycle of the first channel state information and a cycle of the second channel state information when the user equipment allows simultaneous access of the user equipment and the different user equipment;
generating a precoding matrix of each of a first precoder and a second precoder with respect to the user equipment selected in selecting of the user equipment;
precoding the mapped symbols by using the precoding matrixes; and
propagating a precoded symbol over the air through an antenna array including two or more antennas.
